(19) United States
(12) Patent Application Publication
(10) Pub. No.: US 2012/0157307 A1
(43) Pub. Date: Jun. 21, 2012

(54) Foamable Solutions, Dispenser, and Methods

(76) Inventor: John Karl Lampe, St. Paul, MN (US)

(21) Appl. No.: 13/323,642

(22) Filed: Dec. 12, 2011

Related U.S. Application Data
(60) Provisional application No. 61/424,664, filed on Dec. 19, 2010.
(60) Provisional application No. 61/524,712, filed on Aug. 17, 2011.

(51) Int. Cl. A01N 57/18; A01N 25/16

(52) U.S. Cl. 504/116.1; 504/206; 222/190

(57) ABSTRACT

In one embodiment, a foamable solution dispenser, comprising: a foamable solution container and a mechanical foaming head, the foaming head comprising a mixing chamber configured with an air chamber, a liquid chamber and a manifold for receiving and mixing air and the foamable solution into a foam, wherein the foamable solution is disposed in the container and wherein the foamable solution comprises an active ingredient, water and a foaming agent.

In a further embodiment, a foamable solution, comprising an active ingredient for application to plants, water and a foaming agent.

In a still further embodiment, a foamable herbicide solution, comprising an herbicide, water and a foaming agent, wherein the foaming agent is aerobically readily biodegradable.

### CROSS-REFERENCE TO RELATED APPLICATION

This application claims the benefit of U.S. Provisional Application Nos. 61/424,664, filed Dec. 19, 2010, and 61/524,712, filed Aug. 17, 2011, the contents of which are hereby incorporated by reference in their entirety.

### FIELD OF INVENTION

The present invention generally relates to foamable solutions, method of making a foamable solutions, a foamable solution dispenser, and methods of using the foamable solution dispenser. More particularly, the present invention relates to foam or foamable pesticides, such as herbicides, and dispensers to apply foamable solutions such as pesticides or nutrient formulations to plants.

### BACKGROUND OF THE INVENTION

Many techniques, dispensers, and herbicide formulations are used to apply solutions including herbicides to plants such as trees and other woody plants.

There are many pest trees. Many are invasive species that are taking over woodland areas and crowding out native species. Woody invasive plant species not only negatively affect the plant community; they also negatively affect the kinds of animals that can live in that community. Therefore people have long wanted to devise effective ways to control pest trees.

One way to kill an unwanted tree is with a systemic herbicide such as triclopyr (e.g., Garton™ 3A and Garton™ 4 or glyphosate (e.g., Accord™, Glypro™, Rodeo™). For the tree to die, it is generally assumed that a systemic herbicide must eventually reach the phloem, a portion of the plant's vascular system inside the cork (more commonly known as outer bark), so that the herbicide can then be translocated to the roots of the tree. Oregon State University Extension Service, How Herbicides Work, Uptake, Translocation, and Mode of Action, EM8785 (August, 2001). However, more generally, an herbicide may kill a plant by being transported to the living parts of the plant. The translocation may occur in the phloem or xylem and the living parts may include roots, parts of the trunk, buds, leaves, etc. Ballard B D, Nowak C A, Timing of Cut-Stump Herbicide Applications, Arborioculture & Urban Forestry, 2006; 32 (3):118-125.

Probably the most common herbicide application method (for all kinds of weeds) is a foliar application. It is often used with trees. Typically, a person uses a pressurized sprayer (unless the job is a small one) to apply small droplets or a mist containing a pesticide on the leaf surfaces of a plant. The herbicide is absorbed into the plant's vascular system and is translocated to the roots (and other parts of the plant) via the phloem. The sprayer systems used can have one or more nozzles.

Foliar applications have drawbacks when used on trees and woody brush. Trees and shrubs have thick leaves with a heavy cuticle. This protective layer can inhibit absorption of herbicide. Moreover, trees and shrubs are larger plants which means more spray is airborne which can lead to harm to non-target organisms and the environment because of drift or volatilization. The applicator is also exposed to much more herbicide from drift or volatilization and from brushing against wetted branches. High dilution with water is required. This makes spray tanks large and heavy. Finally, it is difficult to keep track of which trees or bushes have been treated because the applied herbicide is often not very visible, especially after it dries on the leaves.

Another technique is a basal bark application. This technique usually involves the use of an herbicide and oil mixture in a pressurized spray system. The applicator sprays the herbicide on the cork at the base of a standing tree or to cut stumps. The solution penetrates the cork. Scientists are unsure how the basal bark application kills the tree. It may function as a “chemical girdle” or the herbicide may penetrate into the phloem and translocate to the roots. In addition to a pressurized spray system, a user can apply the herbicide solution with a wick—a saturated sponge—to the cork.

A basal bark application has the advantage that a standing tree can be treated without having to create an opening through the cork. However, basal bark applications have many drawbacks. The herbicides are typically more toxic; the solution must be mixed; and, herbicide is wasted as it drifts or volatilizes, is deposited in the protective cork layer, or dribbles down onto the ground. This adds expense. In addition, the applications can be more time-consuming than expected. Oftentimes a band of basal bark from 10 to 20 inches around the entire circumference of the trunk must be saturated. This can be difficult when applying in dense thickets or in bushes. Finally, efficacy can be low, especially on thick barked trees or where the application band is insufficiently wide or is discontinuous.

Both the foliar and basal bark application can be considered “topical” application methods. They rely on constituents in the herbicide mixture to help penetrate the protective layers of the plant.

Other application methods are essentially sub-dermal. These include cut-stump, frill (aka “cut-and-squirt”), injection, and various other names. With these applications, the protective layer of the plant (the cork or epidermis) is pierced with a tool or implement to expose inner plant tissue. The herbicide is then applied directly to the inner tissue inside the cork. Glyphosate is often applied sub-dermally. The key with any sub-dermal application is that the application must occur shortly after the outer protective layer is pierced. Otherwise a tree will seal off the wound, and the tissue (especially the phloem) will not absorb the herbicide and translocate it. Experts give different estimates on how long it takes a tree to create a seal over a wound. However, it likely is a process where, as time passes, less and less herbicide is absorbed and translocated. That time period may be measured in seconds, minutes, or hours. However, it is generally assumed the sub-dermal application should be done soon after the cork is pierced—and, the sooner, the better.

One technique that can be considered sub-dermal is the cut stump. This technique involves cutting down a tree and exposing a stump face. An herbicide is applied to the stump face. Usually, a concentrated herbicide formula is used for this application. For example a typical label for a glyphosate-based product might suggest a concentration of 50 to 100% for a cut stump application; whereas only a 5 to 10% solution of the same product may be recommended for foliar applications). Many different dispensers can be used to apply the herbicide: a spray systems; a wick dispenser (including a paint brush), or even a squeeze bottle.

The cut stump method has advantages. It only requires a saw and a dispenser filled with herbicide. The method usually requires less total herbicide than a basal bark treatment because the herbicide can be “mainlined” into the tree's vascular system by treating the plant tissue near the phloem. In addition, less water needs to be carried in the reservoir because of the concentrated solution.

The cut stump method can also have several disadvantages, at least if current application equipment is used. Probably the most difficult thing about this technique is that herbicide must be directed at the phloem or at plant tissue near the phloem. When viewing a stump face, the phloem is typically located in a narrow ring 222 of tissue just inside the cork that makes up the outer layer of the stump. The phloem itself may be very thin even on large trees—less than 0.1 in. thick.

Aiming a spray of an herbicide at the phloem can be difficult and time-consuming. With most prior art application methods, much of the applied mixture misses the stump entirely, hits the heartwood, or hits the cork and dribbles down the side of the stump. According to Ballard and Nowak, as much as half the herbicide may still miss the target using a cut-stump method. Ballard et al. 2006.

A squeeze bottle or similar device can also be used with cut stump applications. The initial application can be more accurate than with a spray. However, with a squeeze bottle application, the herbicide mixture tends to bead or pool and will often dribble down the side of the stump. This is especially true in cold weather. Also, squeeze bottles can leak easily or may get squeezed inadvertently. This can lead to accidental spills or releases.

There are also wick-type dispensers (or wipe dispensers). These can be a simple bristle brush, foam brush, or wick dispenser with a supply system that can feed herbicide to the wick from a reservoir. Wick dispensers have advantages. For example, non-target organisms can generally be avoided because drift is limited. However, metering the spray mixture can be difficult. For example, the wick can become over-saturated or under-saturated during use. If it is over-saturated, herbicide can drip. If it is under-saturated, the applicator may have to wait periodically before applying. If a simple paintbrush is used, an open container must be carried.

This can lead to spills and requires two hands just for the application system. Wick dispenser sponges often get dirty in the field. For glyphosate-based herbicides, this is a major problem because soil and other solids can deactivate glyphosate. Finally, clean-up and storage can be inconvenient.

Another application technique for trees is the frill (or the “cut and squirt”) method. This method involves making downward-directed cuts through the cork layer of a tree with an ax, hatchet, machete, or knife around the circumference of the tree. (Alternatively, holes can be drilled into the trunk around the circumference.) This leaves a series of “chips” (i.e, flaps of bark) attached to the trunk. The flaps might typically be one to five inches in length and a half to three inches wide. Herbicide is applied to the exposed underlying plant tissue on the trunk and to the inside surface of the chip. If the chip is accidently detached from the tree—as often happens due to improper cutting—then the herbicide must be applied to the exposed underlying plant tissue on the trunk, typically a vertical surface to which liquids do not adhere well.

Generally, the same application systems used for a cut stump are used for a frill application. However, spray or squeeze bottle applications may be more commonly used. The chips often are only weakly attached to the trunk and any application of pressure such as with a sponge or brush can break off the chip (i.e., the flap).

One big advantage of the frill method over the cut stump method is that more of the plant tissue near the phloem can be exposed than with the cut stump method. The downward angled cuts run closer to parallel to the length of the phloem and other underlying plant tissues. Therefore, more phloem and underlying plant tissue can be exposed to soak up the herbicide. Another advantage is that the frill method can be used more effectively than the foliar, basal bark, or cut stump on large trees. With the frill method, virtually any sized tree can be treated. A disadvantage of the frill method is that it can be difficult to execute properly. Making downward angled cuts can be hard to do. Oftentimes the cut is not angled properly. In addition, the frill method uses the same prior art dispenser systems used for cut stump applications. If herbicide is sprayed onto the vertical surface of the exposed tissue that remains attached to the trunk, the herbicide mixture often quickly dribbles down the trunk of the tree. Worse yet, spray hitting the cork above the cut may flow into the cut bringing with it contaminants that may reduce the effectiveness of the herbicide.

There are also some specialty dispensers used with frill treatments. One company makes a special hatchet called the Hypo-Hatchet™. The Hypo-Hatchet™ has an injector built into the blade of a hatchet. A tube connects the injector to a backpack tank. The hatchet is used to cut a frill and, when the blade strikes the trunk, a pre-set amount of herbicide is deposited into the tree. The Hypo-Hatchet™ is generally used by large scale operators. It is expensive; the hose can be awkward, especially when working in thickets; the nozzle can get clogged; and the amount of herbicide released cannot be easily varied.

A variation of the frill technique involves making horizontal cuts on a tree trunk with a saw (handsaw or chainsaw) and then applying herbicide into the cut or series of cuts. (A continuous cut around the trunk, a complete girdle, does not have to be executed.) One advantage of this method is that it can be quicker and easier to execute than other techniques. In addition, when the herbicide is applied, herbicide naturally gathers near the phloem and the center portion of the tree trunk in the cut essentially forms a backstop. The difficulty here again is that most prior art application systems are not effective at precisely applying small quantities of herbicide on small discrete areas. Especially if a handsaw is used, the cut groove can be very narrow. Thus, a sprayed herbicide often misses the groove or drips out of the groove onto the outer protective cork where it is wasted. Worse yet, spray hitting the cork above the cut may flow into the cut bringing with it contaminants that may reduce the effectiveness of the herbicide.

A final method discussed here involves injecting herbicide into holes in the trunk. The simplest method of application involves using a drill or boring device and a squeeze bottle. A downward angled hole is drilled into the trunk and an herbicide mixture is injected (or poured) into the hole to fill it. This method has advantages. One is that it there is very little likelihood of off-target applications. Another is that it may be easier to execute than, for example, the frill method. A potential disadvantage is that the method often does not expose much of the tissue near the phloem (or requires a large number of holes or an increase in hole size to expose adequate tissue). Moreover, hitting the plant tissue near the phloem with the applied herbicide can be difficult. For example, if the hole is deep and liquid is directed into the cavity, the top level of the herbicide in the cavity may be well below the point where the cavity and the phloem intersect. In this instance, no herbicide may end up contacting to tissue near the phloem—the most effective area of application. There are several companies that make special injector systems. One is called the Ezject™. These are lances that literally shoot a bullet containing herbicide into the trunk of a tree. These systems are expensive. Reports also indicate that bullets for the Ezject™ are often shot too deep into the trunk to effectively deliver herbicide to the phloem.

The prior art offers many variations. However, the prior art dispensers still suffer from certain shortcomings or limitations. The purpose of the present invention is to overcome these and other shortcomings or limitations in the prior art.

### SUMMARY OF THE INVENTION

The invention in its various embodiments relates to foamable and foamed solutions, a dispenser or dispenser product for dispensing the solutions as a foam for various applications.

In an embodiment of the invention, a foamable solution dispenser is provided. The dispenser of this embodiment comprises:

a foamable solution container and a mechanical foaming head, the foaming head comprising a mixing chamber configured with an air chamber, a liquid chamber and a manifold for receiving and mixing air and the foamable solution into a foam,

wherein the foamable solution is disposed in the container and wherein the foamable solution comprises an active ingredient, water and a foaming agent.

In some embodiments of the dispenser, the active ingredient is an active ingredient for application to plants, e.g., a pesticide, a plant nutrient, or an herbicide. In an specific embodiment the active ingredient is a glyphosate herbicide. In another specific embodiment, the foaming agent is an alkyl glycoside or an alkyl polyglycoside. In yet another, the active ingredient is a glyphosate herbicide and the foaming agent is an alkyl glycoside or an alkyl polyglycoside.

In some embodiments, the dispenser is configured to deliver foam under low pressure. In another embodiment of the invention of the dispenser, the foaming head has a trigger, a nozzle tip, an orifice for delivery of foam. The trigger and nozzle tip can be unitary, a single element or can be provided as two separate elements with the nozzle tip either removably or fixedly (permanently) attached or affixed to the trigger.

In some embodiments of the invention, the active ingredient is an herbicide selected from the group consisting of: glyphosate, 2,4-D, 2,4-MCPA, ametryn, aminopyralid, asulam, atrazine, butafenacil, carfentrazone-ethyl, chlorflurenol, chlormequat, chlorpropham, chlorsulfuron, chlortoluron, cinosulfuron, clethodim, clopyralid, cyclosulfamuron, pyroxsulam, dicamba, dichlobenil, dichlorprop-P, diclosulam, diflufenican, diflufenzopyr, diuron, fluoroxypyr, hexazinone, imazamox, imazapic, imazapyr, imazaquin, imazethapyr, imazosulfuron, MCPA, metsulfuron-methyl, picloram, pyrithiobac-sodium, sethoxydim, sulfometuron, sulfosate, sulfosulfuron, tebuthiuron, terbacil, thiazopyr, thifensulfuron, triasulfuron, tribenuron, and triclopyr.

Additional features or aspects that are incorporated into some embodiments of the dispenser of the invention, either alone or in various combinations, include but are not limited to: 1) the container is non-pressurized; 2) the dispenser is configured to deliver foam under low pressure; 3) the dispenser is configured to deliver foam under pressures of less than 20 psi, or of between less than 20 psi to about 0.5 psi, or from about 15 psi to about 0.5 psi, or from about 15 psi to about 10 psi, or from about 10 psi to about 0.5 psi, or from about 10 psi to 5 psi, or from about 5 psi to about 0.5 psi, or from about 5 psi to about 3 psi, or from about 3 psi to about 0.5 psi; 4) the dispenser is configured to deliver foam under a pressure ranging from about 5 psi to about 0.5 psi; 5) the foaming agent is readily biodegradable; and 6) the herbicide is present in an amount of at least 5 wt %.

In another embodiment of the invention a foamable solution is provided, comprising an active ingredient for application to plants such as a pesticide or herbicide, water and a foaming agent. In yet another embodiment, a foamable solution that consists essentially of an herbicide, water and a foaming agent is provided. In further embodiment of the invention, a foamed herbicide solution is provided, comprising an active ingredient for application to plants, water and a foaming agent. In yet a further embodiment of the invention, a foamed solution, consisting essentially of an active ingredient for application to plants, water and a foaming agent is provided.

Additional features or aspects that are incorporated into some embodiments of the foamable or foamed solutions of the invention, either alone or in various combinations, include but are not limited to: 1) the foaming agent is an alkyl glycoside or an alkyl polyglycoside; 2) the herbicide is a glyphosate herbicide; 3) the foaming agent is present in an amount ranging from about 9.9 wt % to about 0.15 wt %; the foaming agent is readily biodegradable, either aerobically or anaerobically; 4) the foamed solution meets the 15 second stack test; 5) the herbicide is present in an amount of at least 5 wt %; 6) the foamed solution is delivered to a plant surface with low pressure where low pressure is less than 20 psi, or of between less than 20 psi to about 0.5 psi, or from about 15 psi to about 0.5 psi, or from about 15 psi to about 10 psi, or from about 10 psi to about 0.5 psi, or from about 10 psi to 5 psi, or from about 5 psi to about 0.5 psi, or from about 5 psi to about 3 psi, or from about 3 psi to about 0.5 psi.

In a further embodiment of the invention, a method of dispensing a foamable pesticide solution is provide. The method comprises providing a foamable solution dispenser according to an embodiment of the dispenser of the invention; dispensing a pesticide foam from the dispenser; and applying the pesticide foam to a target surface.

The above summary of the present invention is not intended to describe each illustrated embodiment, object, advantage, or use of the present invention. The figures and the detailed description that follow more particularly exemplify these embodiments.

### BRIEF DESCRIPTION OF THE DRAWINGS

FIG. 1A is a perspective view of a foam herbicide dispenser according to an embodiment of the invention.

FIG. 1B is a side view of the Rexam Airspray F2 L11 dispenser (prior art).

FIG. 1C is a side view of the trigger with a non-unitary nozzle tip according to an embodiment.

FIG. 2A is a perspective view of a foam herbicide dispenser being used to apply herbicide to a cut stump according to an embodiment.

FIG. 2B is a perspective view of a foam herbicide dispenser being used to apply herbicide to a frill according to an embodiment.

FIG. 2C is a perspective view of a foam herbicide dispenser being used to apply herbicide to a drilled hole according to an embodiment.

FIG. 2D is a cut-away view of a tree trunk with holes drilled and a method of application according to an embodiment.

FIG. 2E is a cut-away view of a tree trunk with hole drilled and a method of application according to the prior art.

FIG. 2F is a perspective view of a foam herbicide dispenser being used to apply herbicide to a cut in the trunk of a tree according to an embodiment.

FIG. 2G is a cut-away view of a foam herbicide dispenser being used to apply herbicide to a cut in the trunk of a tree according to an embodiment.

FIG. 2H is a perspective view of a foam herbicide dispenser being used to apply herbicide to several small stems of a bush according to an embodiment.

FIG. 3A is a cut-away view of a foam herbicide dispenser according to an embodiment.

FIG. 3B is a side view of a foam herbicide dispenser being used to apply foam herbicide according to an embodiment.

FIG. 4A is a perspective view of a foam herbicide dispenser being used to apply herbicide to a leaf and stem according to an embodiment.

FIG. 4B is a perspective view of a foam herbicide dispenser being used to drizzle herbicide foam onto leaves and stems according to an embodiment.

The invention may be more completely understood in consideration of the following detailed description of various embodiments of the invention in connection with the accompanying drawings, in which:

### REFERENCE NUMERALS IN DRAWINGS

100 dispenser
101 container
102 mechanical foaming head
103 herbicide solution or foamable solution
104 headspace
105 container neck
106 trigger
10 trigger provided with Rexam Airspray F2 dispenser
107 nozzle tip
108 orifice
109 liquid inlet line
110 air inlet
111 mixing chamber
112 herbicide foam or foam
160 air chamber
161 liquid chamber
162 air piston
163 liquid piston
164 manifold
200 dispenser
206 trigger
207 nozzle tip
212 herbicide foam
220 cut stump face
221 mounded arc of foamed herbicide
222 target ring
223 phloem
224 cork
225 heartwood
227 trunk of tree
228 first frill
229 second frill
230 third frill
231 dashed line
232 flap of cork
233 open face cut
234 center sapwood
235 edge tissues
236 first drilled hole
237 liquid herbicide
238 second drilled hole
239 circumferential cut
241a first cut stem
241b second cut stem
241c third cut stem
242 dollop of foam
300 dispenser
301 container
302 dispenser head
303 herbicide herbicide solution or foamable solution
304 headspace
306 trigger
307 nozzle tip
308 orifice
312 herbicide foam or foam
313 nozzle
314 nozzle tube
315 turbulator
316 dip tube
317 vent hole
318 fill line
319 target circle
320 target surface
400 dispenser
412 herbicide foam or foam
421 plant
450 target leaf and stem
451 leaves
452 foam clusters

### DETAILED DESCRIPTION

The following description is presented to enable a person of ordinary skill in the art to make embodiments of the disclosure. Various modifications to the illustrated embodiments will be readily apparent to those skilled in the art. The present disclosure is not intended to limit the described embodiments, but is to be accorded the widest scope consistent with the principles and features disclosed herein. The following detailed description is to be read with reference to the accompanying Figures, in which like elements in different figures have like reference numerals. The Figures, which are not necessarily to scale, depict selected embodiments and are not intended to limit the scope of the disclosure.

As used herein, the term “pesticide” is defined as a chemical used to kill, repel, or control pests. Pesticides can include any herbicide, nematodicide, insecticide, larvicide, fungicide, or rodenticide.

As used herein, the term “foamable solution” or “foam solution,” means a composition comprised of an active ingredient or chemical agent to be delivered or applied to a surface and a foaming agent, e.g., surfactant, present in an amount sufficient to provide a foam when dispensed from a dispenser according to embodiments of the invention.

As used herein, the term “active ingredient for application to plants” means an active ingredient that is intended to be applied to plant surfaces (such as external ones, leafs, stems, blades, etc., or internal ones, cambium, phloem, cork, etc.), for example, as part of a pesticide (such as herbicides, insecticides, etc.) or other agricultural chemicals.

In an embodiment of the invention, a foamable solution is provided. Foamable solutions may be used for various applications. One such application is as a pesticide. However, foamable solutions may be used to deliver various active ingredients, such as plant nutrients and the like. Thus, foamable solutions according to the invention may be useful in many application where a foam delivery system can be utilized to maintain an active ingredient in place such as on a plant surface.

An example of a foamable solution is a foamable herbicide solution made with a concentrated herbicide formulation. The herbicide foam 112 can be created with the dispenser 100 and certain commercially available herbicide formulations and no propellant. This is surprising. In the prior art, for example, most glyphosate formulations as applied are intended to be low-foam. Some formulations actually have anti-foaming agents. See, for example, U.S. Pat. No. 6,107,249 to Wikeley. For applications using pressurized spraying equipment, the generation of foam is generally undesirable.

It has been known in the art to apply foamed herbicides including foamed glyphosate formulations. The Sure Shot Foam™ aerosol device from Scott™ is one example. This system is for foliar applications and uses low concentrations of glyphosate—under 5% of active glyphosate ingredient—as is typical for foliar applications. This system uses propellants.

However, some embodiments of the present invention can utilize concentrations of glyphosate above 5% which are commercially available. At such concentrations, for example, some foamable solutions according to the invention can be created without propellants to make herbicide foam 112 for various uses including “sub-dermal” applications such as the frill, injection, or cut-stump methods where vascular components of the plant such as the phloem can be exposed. With this kind of application, a higher concentration can be desirable.

A high concentration can be desirable because of the way glyphosate acts within the plant's vascular system. It has been observed that with glyphosate, “the faster the uptake, the better, because the first minute amounts of glyphosate delivered to sinks [such as roots] will begin to initiate the self-limitation, which ultimately stops translocation.” See Dill G M, et al., Discovery, Development, Applications and Properties, in Nandula V K (ed), Glyphosate Resistance in Crops and Weeds, History, Development, and Management (2010). By applying a high concentration of glyphosate directly into the vascular system (broadly including the phloem, xylem, cambium and related tissue) extremely fast uptake can occur.

The upper limit for application of an herbicide is likely that concentration which could be locally cytotoxic. The literature and herbicide labels indicate that spray concentrations for sub-dermal applications of glyphosate based solutions can be above a 5% for many tree and shrub species. See, e.g., Ballard et al. 2006. The examples cited below suggest that a glyphosate-based foam made from a solution having more than a 5% active ingredient can effectively kill target species.

The herbicide foam 112 created from a dispenser 100 can be described as having multiple layers of air cells with a foamy appearance. The foam 112 can have a foamy appearance. U.S. Pat. No. 7,666,826 to Smith et al. describes a fifteen second vertical separation test or “gravimetric foam test after 15 seconds” for judging foam. This test was used for a cleaning composition. Under it, a cleaning composition is sprayed as a foam onto a vertical surface such as glass. After 15 seconds, the liquid portion is taken up by one pre-weighted paper towel and the foam portion by a separate pre-weighted paper towel. The weight of the absorbed liquid and the weight of the absorbed foam are calculated. A foam can be characterized as having at least 50 wt. % foam as calculated using this test and preferably at least 70 wt. % and even more preferably at least about 95 wt. % foam. This test as described in U.S. Pat. No. 7,666,826 is incorporated by reference here.

For an herbicide applied to a plant, the weight percent may be lower than 50% and still be suitable for some applications. Cleaning solutions are often applied to glass and other smooth surfaces. An herbicide foam 112 may typically be applied to rougher surfaces. Therefore, the herbicide foam can be effective having at least a 40 wt. % foam, or preferably at least a 50 wt. % foam, or even more preferably at least a 60 wt. % using the gravimetric foam test after 15 seconds.

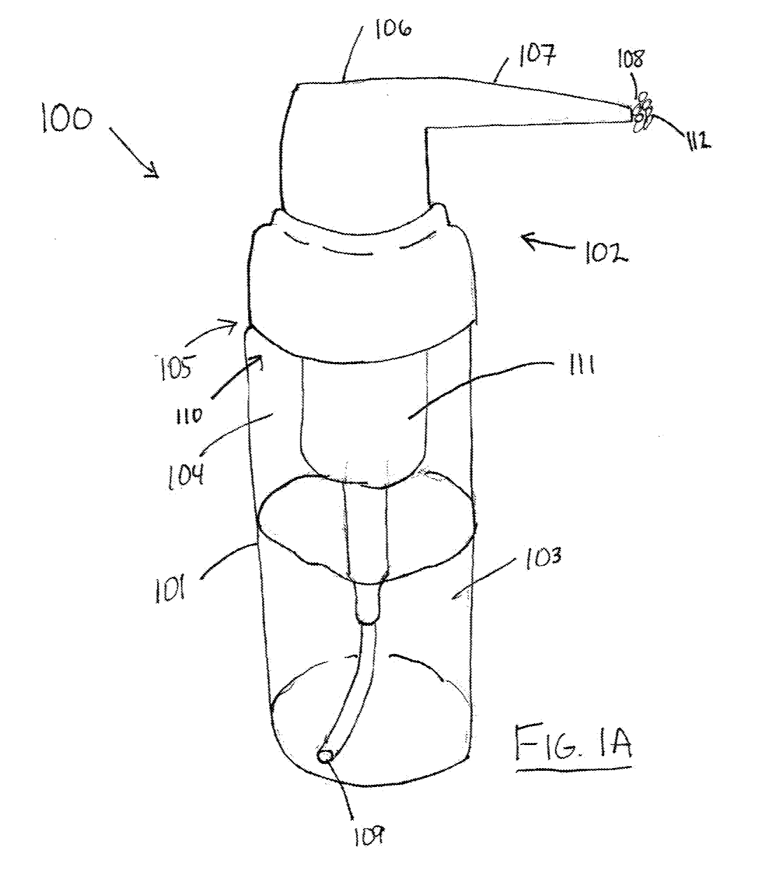

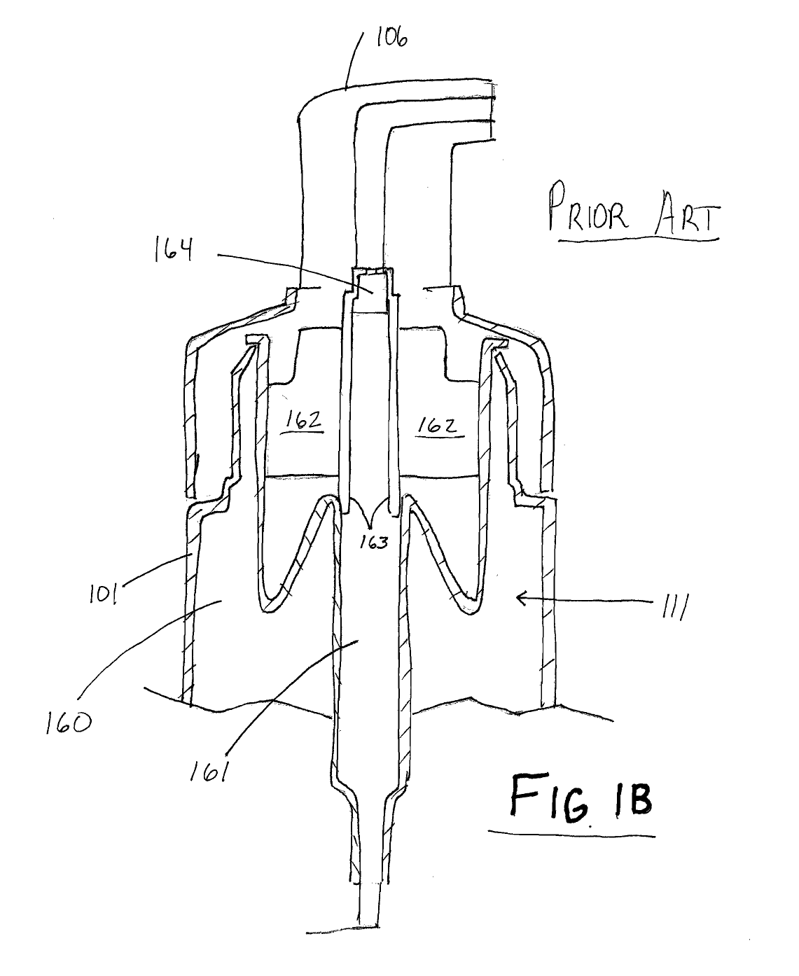

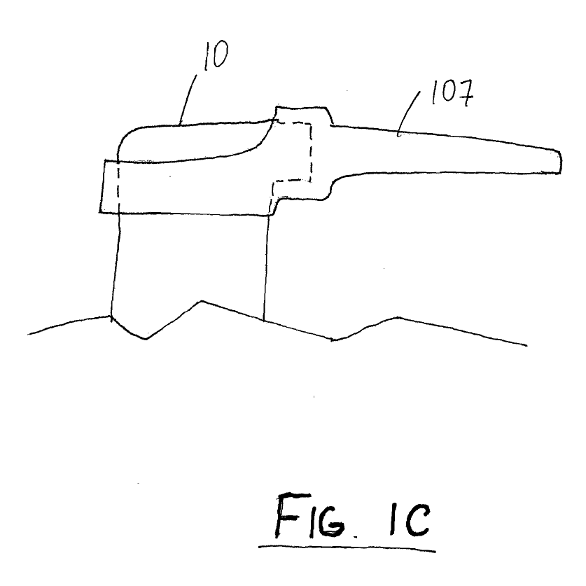

In another embodiment of the invention dispenser 100, contains a foamable solution. In this instance the foamable solution is an herbicide solution 103 This dispenser 100 is shown in FIG. 1A. In this embodiment, the dispenser 100 need not be pressurized. And in fact, an acceptable foam 112 that will remain stable for time sufficient to deliver the active ingredient can be dispensed under low pressure, in part due to the formulation of the foamable solution. As discussed below, it need not have a separate foaming agent to create a herbicide foam when using certain commercially-available herbicide formulations at sufficiently high concentrations. Some are sufficiently foamable as formulated. However, if not, a compatible foaming agent may be added in sufficient concentration to provide an acceptable foam 112.

The dispenser 100 can include a container 101 and a mechanical foaming head 102. The container 101 may include a foamable solution or a liquid herbicide solution 103 (i.e., the solution before being turned into the herbicide foam 112). In addition, air can be present in the headspace 104. The mechanical foaming head 102 can be attached to the container 101 at the container neck 105.

The foaming head 102 can have a trigger 106 which includes a nozzle tip 107 with an orifice 108 where foam 112 is released from the dispenser 100. A small orifice 108 is preferable—for example, one having a diameter of less than 0.1 in. In testing, an orifice 108 of approximately 0.08 in. functions well for most applications. The foaming head 102 can have a liquid inlet line 109 and an air inlet 110. By depressing the trigger 106, air and liquid can be mixed in a mixing chamber 111 and passed through components such as screens to produce foam 112. Depressing the trigger 106 can also force foam 112 through the nozzle tip 107 to dispense the foam 112.

The herbicide solution 103 stored in the container 101 is generally at atmospheric pressure. The foaming head 102 according to the invention utilizes air from the environment to mix with the foamable solution to form a foam. Operating the foaming head 102 may compress the air within the mixing chamber; however, the container 101 is not considered pressurized even though the pressure inside the container may be slightly higher or lower than ambient pressure at times. Therefore the system is not considered pressurized.

Without being bound by theory, Applicant believes that pressure builds inside the device when the trigger 106 is depressed. This pressure can primarily be in two locations: inside the mixing chamber 111 and inside the nozzle extension up to the orifice 108 (and in connected areas in-between). This pressure is not believed to be very high, especially when the foam 112 reaches nozzle extension. Depending on how hard the trigger 106 is pressed, a very low flow rate of about 60 ml/min to 180 ml/min can readily be achieved for foam 112 exiting the dispenser 100. At this low flow rate, moreover, acceptable foam 112 can be produced at an acceptable rate. The release of the trigger 106 can quickly stop flow of the foam 112.

The Rexam Airspray F2-L11 foam dispenser, for example, can be considered “non-pressurized.” The pressure that is needed to produce foam is believed to be created when the trigger is depressed. The mixing chamber on the F2-L11 resembles the mixing chamber 111 shown in FIGS. 1A and 1B. The mixing chamber of the F2-L11 appears to contain or be connected to an air chamber 160 and a liquid chamber 161. An air piston 162 can pressurize air in the air chamber 160 and a liquid piston 163 can pressurize liquid in the liquid chamber 161. The pressurized air and liquid can then be mixed together in a manifold 164. (Note: FIGS. 1A and 1B are not intended to identify all the components nor all aspects of the components of prior art foam dispensers such as the F2-L11. Many other components may be necessary, such as check valves, seals, etc., to make the dispenser function properly.)

The dispenser 100 as described overcomes key disadvantages of prior art application systems, particularly prior art pesticide delivery systems. A low pressure liquid system (i.e., non-foam-based system) such as a squeeze bottle that produces larger droplets or a stream generally has a relatively large orifice. A squeeze bottle can be held close to the target to provide decent accuracy and can also avoid problems associated with drift or volatilization (because of the larger droplets). However, the large droplet size results in beading (due to high surface tension) on the target surface and often results in the solution flowing off the target surface. This wastes material; threatens non-target organisms; and reduces efficacy.

A pressurized prior art spray system, especially with smaller orifices, can produce less beading. However, small droplets decrease spray accuracy and potentially lead to volatilization and drift. Moreover, an application under pressure can cause splatter or “rebound” as the droplets hit the target surface, especially when the dispenser 100 is held too close to the target. For example, pressurized systems (for example, creating pressure either with a pump or propellant) cause the droplet to hit the surface with sufficient velocity that the material may not stick to the surface. This can be especially true if the surface is a leaf or other smooth surface.

The dispenser 100 according to an embodiment of the invention, on the other hand, delivers foam 112—that has a low surface tension—that sticks better to most surfaces, especially ones with a little roughness. Moreover, the dispenser 100 does so at low velocity due to low pressure delivery so precision can be enhanced, and backsplash or splatter can be avoided.

The nozzle tip 107 with the small orifice 108 appears to do at least a number of things to improve the function of the dispenser 100. First, it slows the release of foam 112 through the orifice 108 but without creating too much pressure build-up. This is important for precise applications of the herbicide foam. The foam 112 is not jetted out of the dispenser 100. In fact, during application, the release of foam 112 is sufficiently slow that it can actually form a continuous foam 112 column between the nozzle tip 107 and the treatment surface.

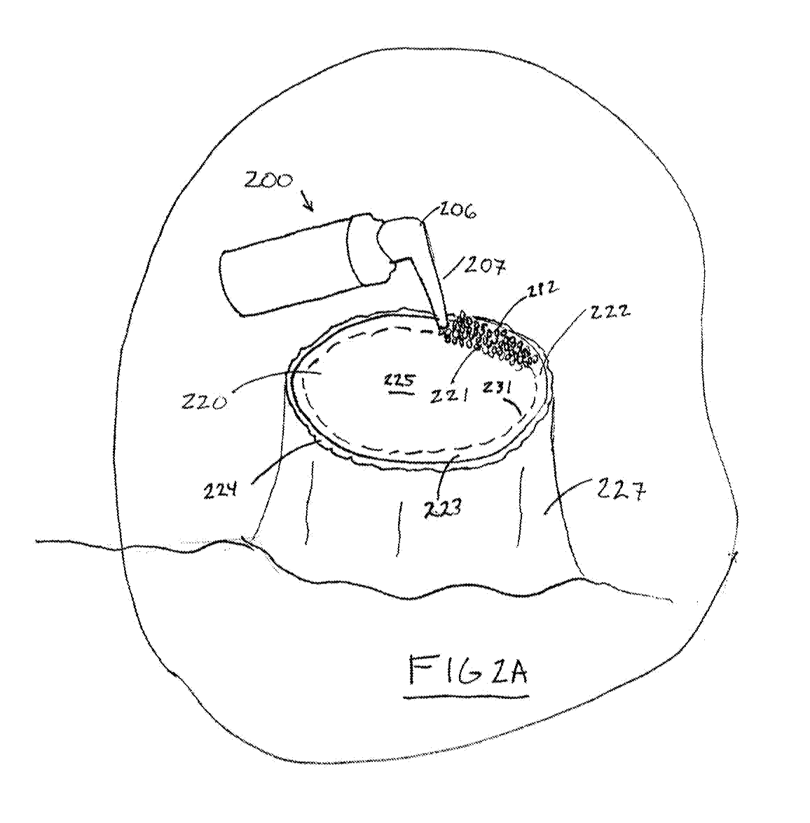

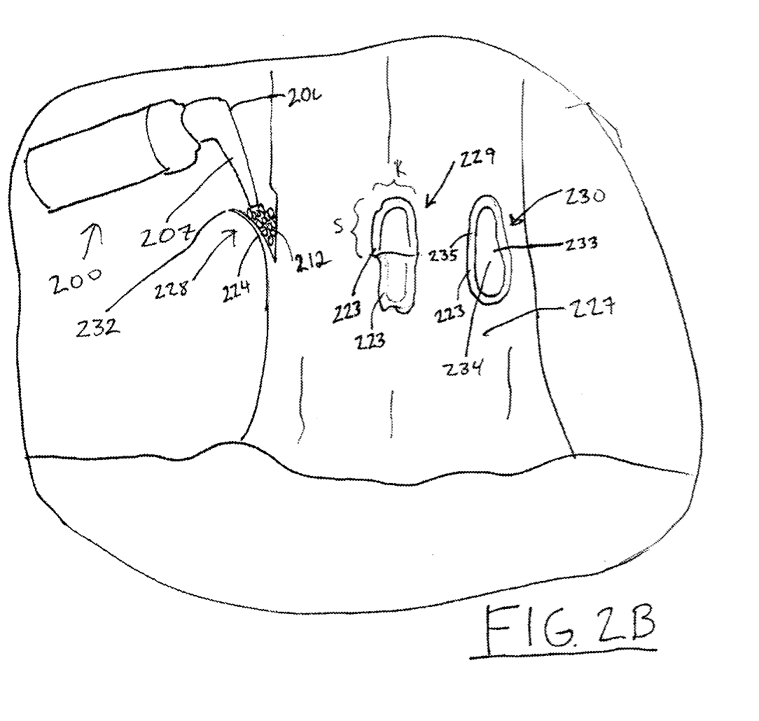

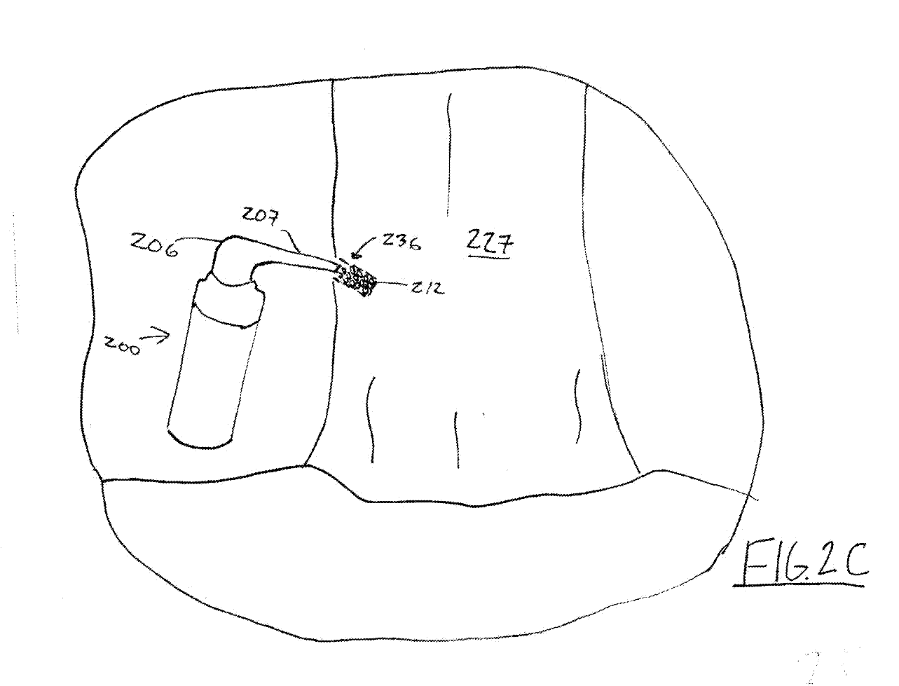

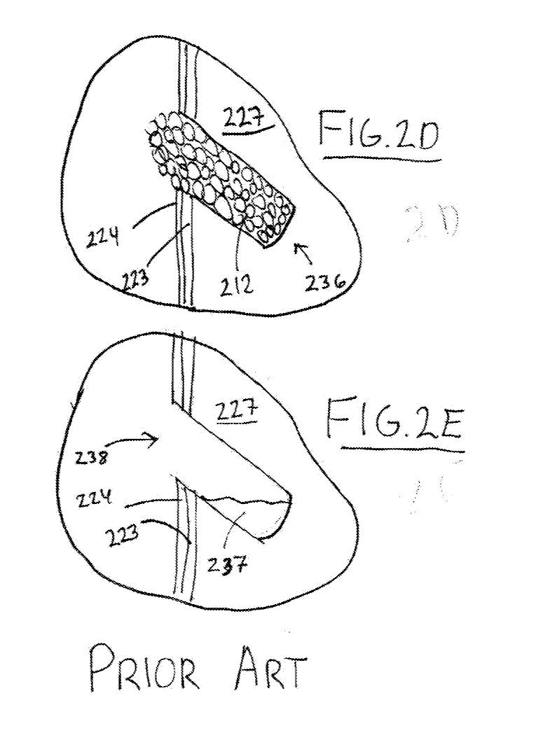

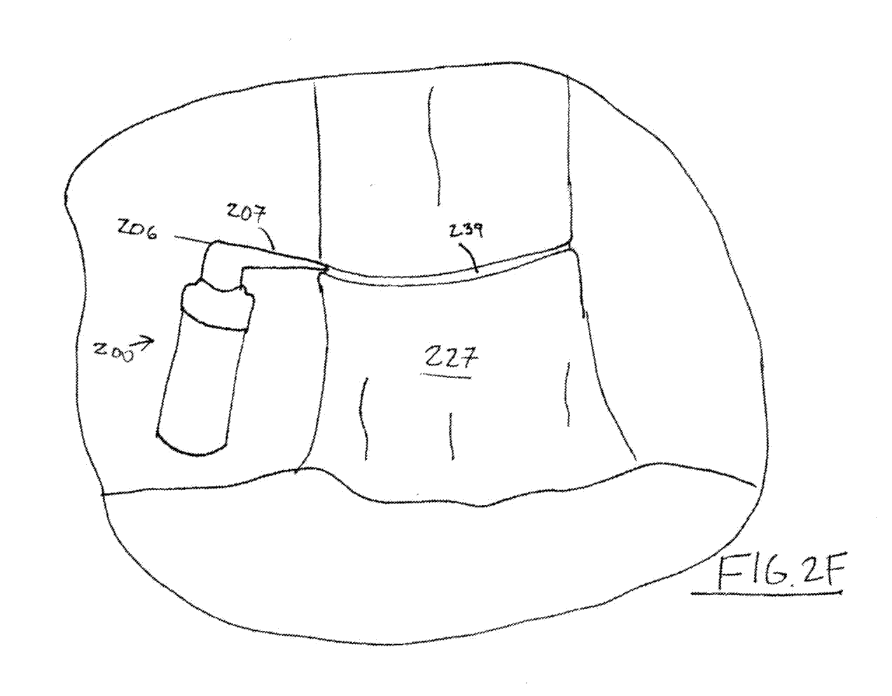

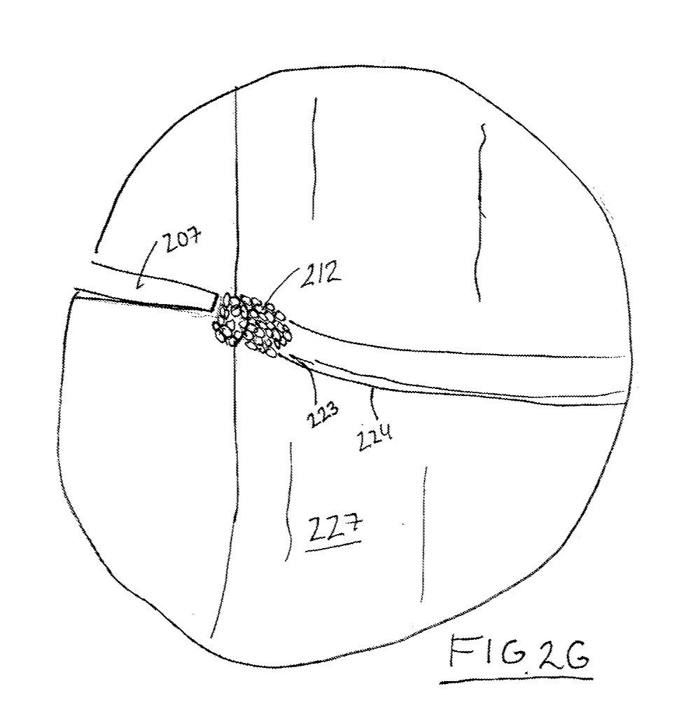

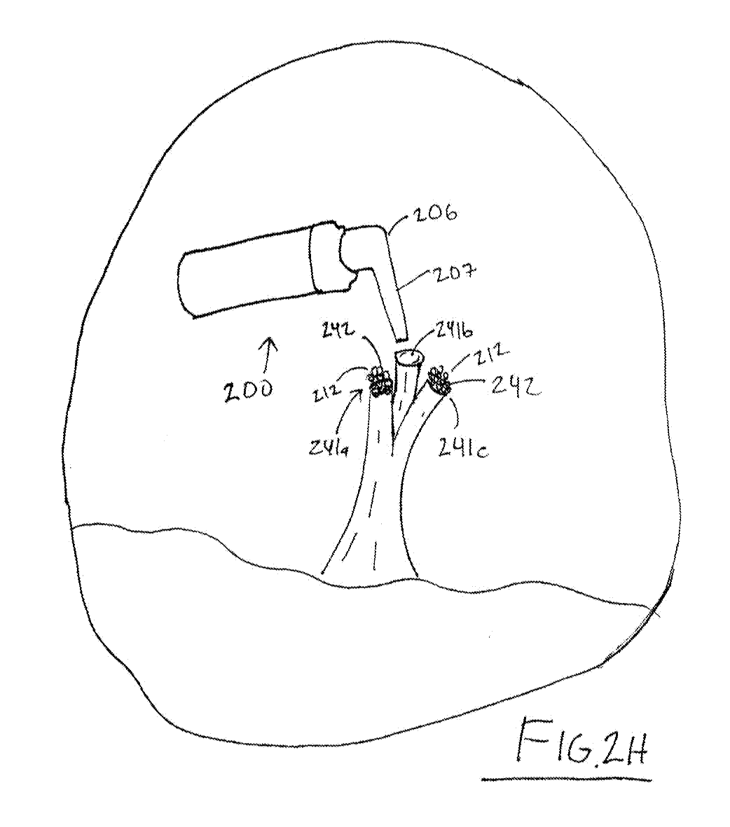

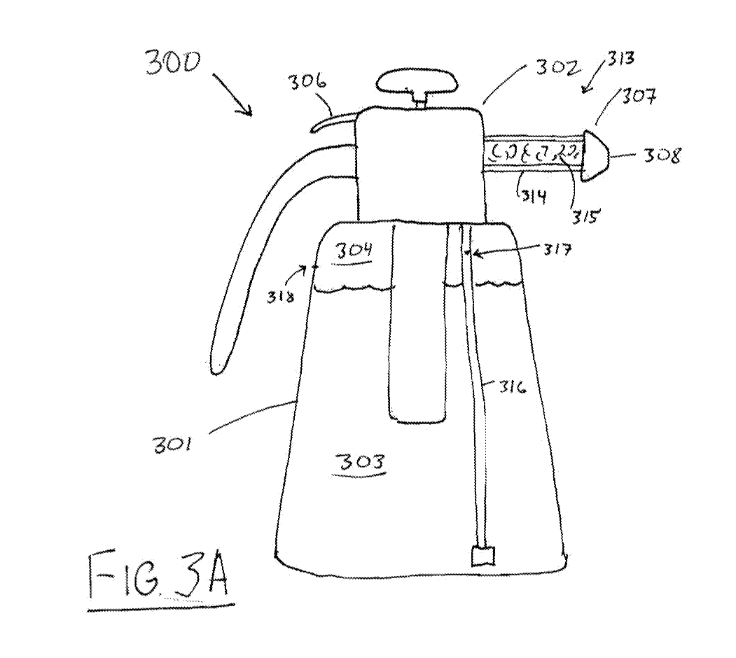

Moreover, the slow release of the foam 112 prevents splatter, especially when the application is to small cavities such as the drilled hole shown in FIGS. 2D and 2E. If a liquid herbicide solution (whether foamed or unfoamed) is jetted into a small cavity such as this, the pressure can cause liquid to be splattered out of the hole or even back at the applicator. This not only wastes herbicide, it can be dangerous.

Second, the nozzle tip 107 and small orifice 108 smooth out the jerkiness that can be present when the trigger 106 is depressed. This allows for a more even flow of the foam 112 out the orifice 108. If foam 112 is to be deposited along a line, for example, the mound of foam 112 deposited on a surface can be more uniform—resembling in appearance a ridge rather than several small piles of foam 112.

Third, the nozzle tip 107 improves the quality of the foam 112—making the bubbles more resilient. This means that the foam 112 lasts longer after application. This is important for a number of reasons. It allows for concentration of the foam 112 near the targeted area—e.g., the phloem. Since the targeted area is so small and will only translocate herbicide for a limited time, it is important to concentrate herbicide there. The foam 112 composition is described in more detail below. Fourth, the nozzle tip 107 can reach into recesses such as a drilled hole very easily. This again improves accuracy.

Finally, the nozzle tip 107 can be used as a spreader (or spatula) to move foam 112 around on a surface. This can be helpful to ensure saturation of critical tissue such as that tissue near the phloem. As the nozzle tip 107 is moved when in contact with the foam 112, the foam 112 can be stretched or pushed to the desired shape and thickness. This allows for very precise applications and full coverage of the target areas.

Some of the components for the dispenser 100 depicted in FIG. 1A are commercially available. Rexam Airspray Inc., 3768 Park Central Blvd. North, Pompano Beach, Fla. 33064, produces a number of non-pressurized foam dispensers which can be modified by replacing the existing trigger 10 shown in FIG. 1B with a trigger 106 that includes a unitary nozzle tip 107 with the small orifice 108. Alternatively, a non-unitary trigger nozzle tip 107 may be created as shown in FIG. 1C.

The dispenser 100 and its components can be made of many different materials. For most applications, most of the device can be made of plastic components formed with injection molding. Certain components such as springs or screens may preferably be made of other materials such as metals. However, other materials and other forming processes may also be suitable.

In some embodiments, the dispenser 100 itself can be relatively small—smaller than prior art applicators. The dispenser 100 uses a concentrated herbicide solution 103. The dispenser 100 uses the concentrated herbicide solution 103 efficiently because of the accuracy of the dispenser 100 and because the foam 112 can stay in place better. This means less herbicide solution 103 needs to be carried. However, for larger applications, a larger dispenser (not shown) may be suitable.

In certain embodiments, the entire height of the dispenser 100 can be under seven inches and the container 101 can have a diameter of two inches. The nozzle tip 107 might extend 1 to 5 inches or so. Such a size could make the dispenser 100 very easy to hold in one hand. An advantage of the dispenser 100 is that an implement such as a drill, saw, or other cutting device can be held in one hand and the dispenser 100 in the other. Of course, dispensers of many different sizes or configurations can also be used for different applications.

The dispenser 100 can contain many different kinds of pesticide or herbicide solutions or other foamable solutions. The herbicide solution 103 can have an active ingredient such as a glyphosate-based compound. Glyphosate is very effective for sub-dermal (as well as foliar) applications for many plants.

In testing commercial herbicide formulations, certain ones produced acceptable foam 112 in the dispenser 100. Nufarm Credit™ with an EPA registration number of 71368-65 is a glyphosate-based concentrated herbicide with listed pesticidal active ingredients totaling about 34%. As is standard practice, no inactive ingredients are listed on the label, so it is unclear what surfactants may be included in Nufarm Credit™. Nufarm Credit is labeled for cut stump, injection, and frill applications. The label recommends 50 to 100% concentrations for these kinds of applications.

Applicant conducted testing of foam delivery from the dispenser 100, using a 100% concentration of the Nufarm Credit herbicide in a solution. The dispenser 100 produced acceptable foam 112 with the 100% concentration of Nufarm Credit herbicide solution. The foam 112 can be described as having the consistency somewhere between wet foam and shaving cream-type foam. In this testing Applicant added no additional foaming agent to the herbicide solution 103.

Commercially available glyphosate formulations often contain surfactants such as alkyl glycosides. Such surfactants are included, for example, as wetting agents typically in small quantities. Alkyl glycosides are known to foam well and are used in agriculture for foam markers. Kasebaum, J W, Surfynol surfactants as defoamers for glyphosate formulations with alkyl glycoside surfactants in pesticide formulations and application systems: 13th Volume, ASTM STP 1183, Berger P D, Devisetty B N, Hall F R, eds., American Society for Testing and Materials, Phil. 1993. However, it is not the foaming characteristic that is sought in prior art herbicide formulations. In fact, since foaming is undesirable in prior art herbicide spray equipment, quantities of any foaming surfactant are usually limited or are counteracted with a defoamer or antifoaming component formulation to reduce foaming. Therefore it is surprising that a commercially available herbicide formulation such as Nufarm Credit herbicide solution can be made to foam well in any dispenser.

With the low flow rate of the dispenser 100, foam 112 deposits of different sizes and shapes can easily be created. For example, a small dollop of foam 112 anywhere from approximately 0.25 in. to 2.0 in. wide and 0.25 to 2.0 in. high can be formed. Alternatively a long mound of foam 112 approximately 0.3 in. to 0.75 in. wide and 0.25 in. to 0.5 in. high can be formed. These shapes can be very useful in applying the herbicide foam 112 to plants using the dispenser 100. Many other foamed deposits can be created using the dispenser 100 and the herbicide solution 103 described above. Using dispensers and herbicide solutions according to other embodiments can allow creation of foam deposits of other dimensions and shapes.

FIGS. 2A to 2H show methods for herbicide application using a dispenser 200. The dispenser 200 discussed in relation to FIGS. 2A to 2H can be similar to the dispenser 100. The herbicide solution can be the same one described above.

The application methods according to embodiments of the invention described in FIGS. 2A to 2H can be described as sub-dermal applications. Herbicide labels generally suggest applications to the cambium or living tissue. See, e.g., Label for Nufarm Credit™ with an EPA registration number of 71368-65. For the purposes here, it is assumed that optimal application is to tissue near the phloem which may include the cambium and other tissue. However, if an herbicide or other chemical should be directed at another part of the plant—the heartwood 225 or cork 224, for example—the application methods described here can be adjusted.

FIG. 2A depicts the application of an herbicide foam 212 to a fresh cut stump face 220. A mounded arc 221 of herbicide foam 212 is deposited near the outside perimeter of the stump face 220. This ring of plant tissue just inside the cork 224 and located near the phloem 223 can be considered the “target ring” 222. The target ring 222 can include the phloem 223 and plant tissue near the phloem 223. The width of the target ring 222 can extend from tissue located toward the center of the tree trunk 227 (represented by the dashed line 231) to the inside of the cork 224. The target ring 222 may not necessarily be circular, since trees are not perfect cylinders. In addition, the ring 222 may not be fully connected around the circumference of the tree since defects such as scars or wounds may interrupt the continuity of the phloem 223 around the tree trunk 227.

If the full tree is considered, the target ring 222 is a cross-section of a generally cylinder-shaped portion of the tree just inside the cork 224 representing tissue near the phloem 223. For a sub-dermal application of herbicide, the applied herbicide foam 212 should preferably be deposited on some portion of the tissue near the phloem 223 in order to increase the likelihood of destroying the tree. It is assumed that herbicide applied to the cork 224 or inside the target ring 222—at the heartwood 225 for instance—is wasted because this tissue is dead. However, the dispenser 200 could be utilized to apply an herbicide solution to these areas too.

In experiments on a stump approximately 4 in. in diameter at the face 220, approximately one to two pumps of the trigger 206 can deposit a nearly continuous, mounded arc 221 of foam 212 approximately 0.4 in. wide and 0.3 in. high positioned on the target ring 222. For many applications on small to medium trees (with stumps from 2.0 in. to about 20.0 in.), a mounded arc 221 of foam 212 of this dimension should be sufficient to cover the target ring 222 effectively and ensure effective control. For larger trees, a larger dispenser (not shown) may be useful.

### Example 1

Applicant conducted foam deposition experiments on buckthorn (Rhamnus cathartica) were conducted in October and November in Minnesota using a foamed herbicide solution. The experiments included cut stump applications made to stump faces approximately 2 to 4 in. above grade. The treated trees were less than approximately 4 in. in diameter at the base.

The foamed herbicide solution was prepared using a commercially available herbicide solution with concentrations of glyphosate above 30%. Foamed herbicide was created from an undiluted herbicide solution, i.e., straight from the container: Nufarm Credit™ with an EPA registration number of 71368-65 is a glyphosate-based concentrated herbicide. Nufarm Credit™ herbicide is produced by Nufarm Inc., 150 Harvester Dr., Burr Ridge, Ill. 60527. It contains a glyphosate concentration in excess of 30%.

Nufarm Credit™ herbicide is labeled for cut stump, injection, and frill applications. The label recommends 50 to 100% concentrations for these kinds of applications. In the experiments, the foamed herbicide solution of 100% concentration of Nufarm Credit (i.e., undiluted) was applied to cut stump faces in the buckthorn. The cut-stump application technique described above was used to apply the foamed glyphosate solution on or near the phloem of the tree, i.e, the target ring. After the dispenser was primed with a depression of the trigger, the foam created could be described as a having a consistency between a wet foam and a shaving-cream foam.

Applicant observed that the tree died and believes that the application of the concentrated foam using the cut-stump method caused the death of the trees. Therefore, it appears the herbicide was translocated to critical sinks in the tree, and it does not appear that the foam made from the concentrated glyphosate solution—about 30%—using the cut-stump method was locally cytotoxic.

Even if a stump is cut at an angle and the stump face slopes (not shown), the foam should be sufficiently sticky to hold onto the stump face. The cut of a saw also typically leaves a slightly roughened surface. This also helps the foam as opposed to a liquid maintain its position even on a sloping stump face. The generally rough surface of a cut-stump contrasts with the sometimes waxy surface of a leaf. Fluid that forms in the interface between the foam and the leaf surface can be sufficiently slick that the foam can slide off a surface such as a leaf.

FIG. 2B depicts an embodiment of a method of applying an herbicide foam 212 to frills in the trunk 227 of a tree. The frill cuts—identified as first frill 228, second frill 229, and third frill 230—have exposed inner plant tissue near the phloem 223. With one-half to two pumps, a small quantity of foam 212 can be deposited in the pocket formed by the flap 232 of cork 224 shown in the first frill 228 shown in FIG. 2B. (The second frill 229 shows the dimensions of a typical frill—in this case “S” could be 3 in. and “K” could be 1.5 in.)

On the third frill 230, the flap of cork has been detached leaving just the open face cut 233 on the trunk 227. Foam 212 can be applied to this entire cut surface 233. However, in some instances, the center of the third frill 230 could be sapwood 234 which can be wet and slick. Edge tissue 235 exterior to the sapwood 234 may be exposed. These edge tissues 235 might include the phloem 223 and tissue surrounding the phloem 223. Typically these edge tissues 235 are less slick than the sapwood and may even be roughened from the shearing action of the cut. By applying the foam 212 to the edge tissues 235, the foam 212 can be held in place even though the surface may be vertical and the center area of sapwood 234 slick.

### Example 2

Applicant conducted foam deposition experiments on buckthorn (Rhamnus cathartica) were conducted in October and November in Minnesota using a foamed herbicide solution. The experiments included frill applications made to the trunk 3 to 6 in. above grade. The treated trees were less than approximately 4 in. in diameter at the base.

The same herbicide foamable solution 103 used in Example 1 was used. The frill application technique described below was used to apply the foamed glyphosate solution into frills that appear to have exposed the phloem of the tree. After the dispenser was primed with a depression of the trigger, the foam created could be described as a having a consistency between a wet foam and a shaving-cream foam.

Applicant observed that the tree died and believes that the application of the concentrated foam using the frill method caused the death of the trees. Therefore, it appears the herbicide was translocated to critical sinks in the tree, and it does not appear that the foam made from the concentrated glyphosate solution—about 30%—using the frill method was ineffective or locally cytotoxic.

FIG. 2C depicts a method of application, according to an embodiment of the invention, into a hole 236 drilled into a tree trunk 227. For a small tree trunk 227, the hole 236 might, for example, be approximately 0.50 in. in diameter and 0.5 in. deep. A smaller or larger tree trunk could require holes of different dimensions. The dispenser 200 is used to inject a small quantity of the herbicide foam 212 into the hole 236 as shown in FIGS. 2C and 2D. The amount of herbicide foam 212 injected might be less than a full pump of the trigger 206.

Using the foam dispenser 200 for this method of application is advantageous. As shown in FIG. 2E, a prior art liquid herbicide 237 injected into the second hole 238 may settle to the bottom of the hole 238 and not actually come in contact with the tissue near the phloem 223. Using foam 212 from the dispenser 200, on the other hand, can allow for the overfilling of the hole 236. This helps ensure foam contacts the tissue near the phloem 223.

In addition the low flow dispenser 200 helps avoid back splash. This can be a particular problem with injection of an herbicide solution (liquid) into a small hole 238. Even with just moderate nozzle pressure, the herbicide solution from a prior art dispenser can quickly fill the hole and spurt out. This not only wastes herbicide, it also can be a safety problem for the applicator. The application method depicted here avoids that problem.

FIGS. 2F and 2G show the application, according to an embodiment of the invention, of herbicide foam 212 to a circumferential cut 239 to the trunk 227 of a tree. (The cut 239 can but does not have to be made around the entire circumference of the tree.) Alternatively, a series of cuts could be made at a downward angle (not shown). The dispenser 200 can be used to apply foam 212 into the cut 239.

Prior art application methods placing liquid streams, droplets, etc., into a cut 239 like this one create several problems, some of which are mentioned above. Major ones are that it is hard to aim liquid herbicide solutions using prior art dispensers into such a small cavity, especially if the cut is made by a handsaw whose blade may be well under a tenth of an inch thick. Therefore, it is hard to get enough of the spray into the cut where it is needed. In addition, a liquid tends to quickly run out of such a cavity.

The herbicide foam 212, on the other hand, can cling to the cut 239. As shown in FIG. 2G, the foam 212 can actually overfill the cut 239. As with the hole 236 described above, this is advantageous because the foam 212 will more likely contact inner tissues near the phloem 223. Also, using the low flow dispenser 200 avoids splatter and backsplash. A precise measured amount of foam 212 can be applied without splatter. Finally, with this application method, a column of foam 212 can contact both the dispenser's nozzle tip 107 and cut 239. The applicator can use the elasticity of the foam 212 to stretch or push the foam 212 along the length of the cut 239 to ensure good coverage of the area of tissue near the phloem 223.

FIG. 2H shows the application, according to an embodiment of the invention, of foam 212 to a small cluster of small cut stem faces, 241a, 241b, 241c. These might be stem faces, 241a, 241b, 241c of an invasive bush or other undesirable plant. The stems can be an eighth inch in diameter. Using prior art dispensing equipment it can be very hard to aim an herbicide solution from a spray bottle or spray wand at such a small target. Moreover, much of the liquid may collect on the cork 224 of the stems or run off. It is also very hard to know if the herbicide solution was in fact deposited on the stem face.

The method shown in FIG. 2H has advantages. The method can be used preferably on small stem faces 241a, 241b, 241c—perhaps those less than an inch in diameter. The foam 212 can be applied with the dispenser 200 in very close proximity to the surface of the stem faces 241a, 241b, 241c—from about a half of inch distance from the stem faces 241a, 241b, 241c. The foam can then be applied with the foam forming a column of continuous foam between the nozzle tip 207 and the stem faces 241a, 241b, 241c. The dollops of foam 212 can have a peak about a quarter to an inch tall. Alternatively, the foam 212 can be released from the nozzle tip 207 and allowed to gather at the nozzle tip 207 while the dispenser 200 is held at a greater distance from the stem faces 241a, 241b, 241c. Then the nozzle tip 207 can be brought into closer proximity with the stem faces 241a, 241b, 241c. The foam 212 can then be transferred from the nozzle tip 207 to the stem faces 241a, 241b, 241c. Again, advantages include the fact that the foam 212 can be mounded on the target site. For small stem faces 241a, 241b, 241c like this, this is very advantageous because the surface area is so limited.

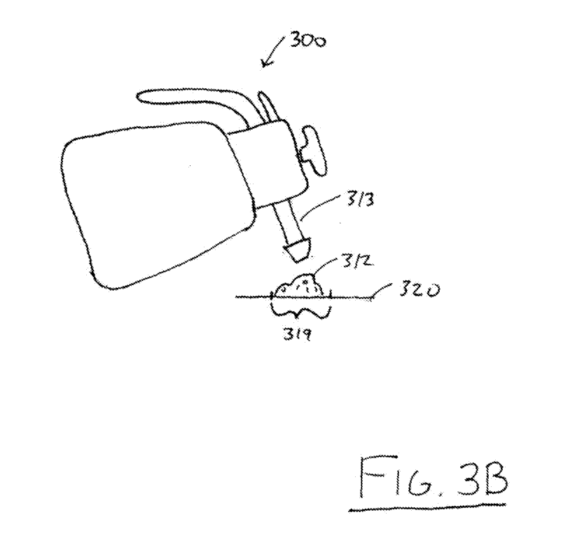

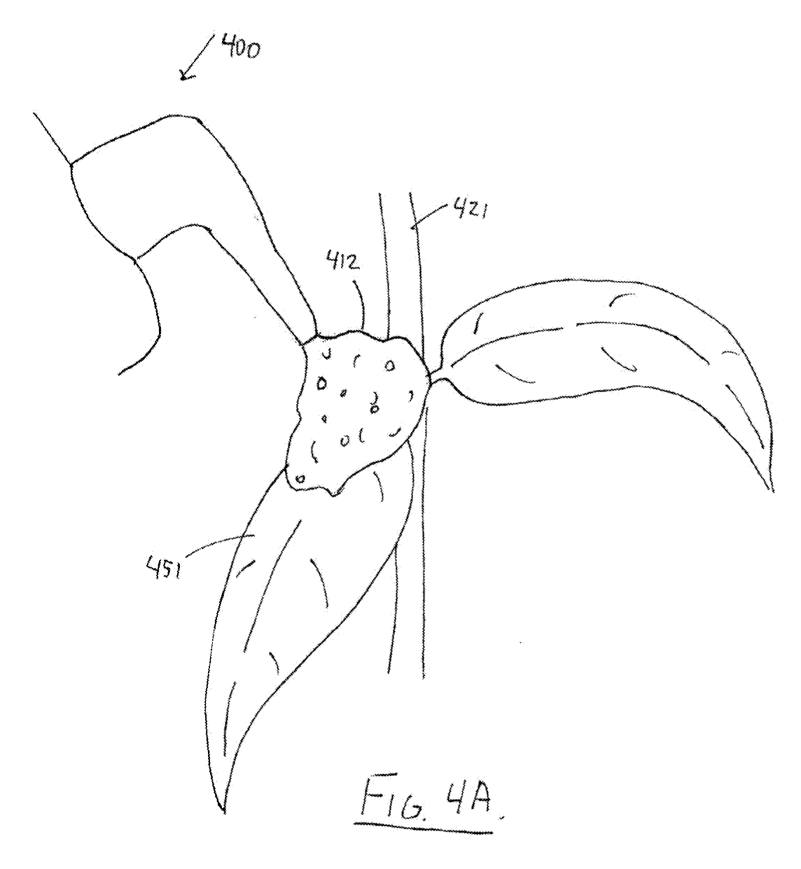

In another embodiment of the invention a method for creating herbicide foam 312 using a pressurized dispenser 300 that dispenses the herbicide foam under low pressure is provided. The pressurized dispenser 300 as shown in FIG. 3A can be pressurized in different ways. In at least one embodiment, the dispenser 300 can be pressurized with air and without a propellant. It can have an added foaming agent. The herbicide foam 312 can have a concentrated herbicide formulation.

The foam 312 can also be made without a propellant. For purposes of this invention, air is not considered a propellant even though the air may be compressed in the dispenser 300. Typically with an aerosol, a pressurized container stores a composition that includes propellant such as fluorocarbons, chlorofluorocarbons, and alkanes such as butane, ethane, isobutane, and propane. When the composition passes through a nozzle, the propellant expands and transforms the composition into foam. The dispenser 300 described here and in earlier embodiments 200, 300 can use air from the environment and mix the air with a foamable liquid to form foam 312 without the aid of a propellant.

Some of the components for the dispenser 300 depicted in FIG. 3A are commercially available. Impact Products, LLC, 2840 Centennial Road, Toledo, Ohio 43617-1898, produces a number of air-pressurized dispensers which can be modified to produce acceptable foam 312. One of those dispensers is the 48-oz. Jr. Pump-Up Sprayer, Model 7548. At least two modifications can be made so the dispenser 300 can produce acceptable foam 312. First, the nozzle 313 can be disassembled and a turbulator 315 inserted into the nozzle tube 314 as shown in FIG. 3A. The turbulator 315 is any material or device that can cause turbulence when liquid, air, or combinations thereof pass through it. In this case, the turbulator 315 can be a piece of a non-woven reticulated (fibrous) polyester foam material. Such material is commonly known as Scotchbrite™. The nozzle tube 314 can be of various lengths. For most applications the nozzle tube 314 can be approximately one to two inches long. The turbulator 315 can completely fill the nozzle tube 314 or some portion of it.

Second, a vent hole 317 can be made in the dip tube 316 of the dispenser 300 approximately 1 in. below where the dip tube 316 attaches to the dispenser head 302. This location should in the headspace 304 well be above the fill-line 318 of the container 301 in order to prevent the solution 303 in the container 301 from entering the vent hole 317. The dip tube 316 that accompanies Jr Pump-Up Sprayer, Model 7548 has an outside diameter of approximately 0.125 in. and in inside diameter of approximately 0.13 in. The vent hole 317 can have a diameter of approximately 0.04 in. This would make the cross-sectional area of the vent hole 317 approximately 10% of the cross-sectional area of the dip tube 316 inside diameter. A vent hole 317 having a cross-sectional area approximately 5% to 20% of the dip tube 316's cross-sectional area should produce acceptable foam 312 in most circumstances. If the vent hole 317 is too large, the dispenser 300 will sputter as foam 312 is dispensed. A vent hole 317 that is too large creates unacceptable variation foam quality and in the speed of foam 312 production. If the vent hole 317 is too small insufficient air will be mixed the solution and the quality of the foam 312 may decrease and become very watery. In fact, if the vent hole 317 is really small, the dispenser 300 will not produce foam 312.

It is preferable for many applications to have the dispenser 300 produce foam 312 at a pressure sufficiently low to accomplish certain tasks. For example, for many applications it may be desirable to make targeted foam 312 deposits with great accuracy. This may be required for applications to leaves and stems or to small cut stems. Moreover, it may be desirable to stack or pile the foam 312 from approximately 0 to 2 in. high without causing spatter that could harm off-target plants. Finally, the “stackability” of a foam 312 also provides some indication of how wet the foam 312 is. Wet foam will not stack high. Dry foam will stack high. A foam that is too wet may slide or drip off surfaces, especially vertical ones. Foam that is too dry may not carry enough active herbicide ingredient and may blow off surfaces such as leaves. Neither extreme is preferable for most applications.

A test for determining the “stackability” of foam can be used. The test can be called the “foam stacking test.” The nozzle of the dispenser 300 can be held near a horizontal surface as shown in FIG. 3C with a target circle 319 having a 1.5 in. diameter. When foam 312 is dispensed at the target circle 319, the deposited foam 312 should maintain a desired height, e.g., 0.5 in. to 2.5 in., for at least 15 seconds and should comprise a mass of foam 312 within the boundaries of the circle 319 without any spatter outside the circle 319. The target surface 320 should preferably be non-absorbent glass to minimize variation.

The criteria could be varied. For example, in some instances it may be desirable that foam 312 could be stacked 2 in. to 4 in. high. For larger stacks, the diameter of the circle 319 could be expanded to 1 in. or 2 in. For most applications described here, it would be preferable to have a foam 312 that could stack at least 0.5 in. to 2.5 in. high within a 1.5 in. circle 319 for at least 15 seconds. However, for other applications different criteria may be desirable.

The foam stacking test could be used to test any dispenser, 100, 200, 300 described here or other devices designed to dispense foam at a certain level of pressure.

Low-pressure dispensing as described here could be done using a device that maintains air or liquid under high pressure (not shown) in a container. Such a high pressure device (not shown) would have to have a control mechanism sufficiently sensitive that foam could be dispensed at low-pressure.

The dispenser 300 described here can have several advantageous features. First, the dispenser 300 can have many of the advantages of the dispensers 100, 200 described in the first two sets of embodiments. Second, the dispenser 300 can be less fatiguing than non-pressurized foam dispensers, since with the dispenser 300a lever or button does not have to be pumped each time foam 312 is dispensed. Third, work can be done faster than with non-pressurized dispensers for the same reason. Fourth, because the dispenser 300 can work without propellants, there are advantages. The dispenser 300 can be much more economical than dispensers with propellants; solutions can be mixed more easily by the user; and environmental concerns related to many propellants can be avoided.

In yet another embodiment of the invention, a method for creating concentrated herbicide foam 412 for application to plants 421 is provided. The concentrated herbicide foam 412 can be generated by a dispenser 400 (which as depicted resembles dispensers 100, 200) and applied in its concentrated form to any portion of the plant 421 which can take up a water-based herbicide. This generally is living portions of the plant 421 including the leaves, green stems, and sub-dermal tissue such as the phloem, xylem, cambium, etc.

The concentrated herbicide foam 412 can be generated using various foaming devices including the dispensers discussed above in the first, second, and third set of embodiments. Other devices, however, could also be used. The concentrated herbicide foam 412 could be generated without propellants.

The concentrated herbicide foam 412 would be particularly useful for sub-dermal applications. Sub-dermal applications can be considered any application of a chemical including an herbicide directly to tissue inside the epidermis or periderm of a plant including the cambium, phloem, or xylem. Dermal applications in contrast can be considered applications to the outer tissue of a plant including the epidermis. Dermal applications can be considered to rely on translocation rather than direct application to reach tissue such as the phloem.

The concentrated herbicide foam 412 could also be useful for dermal applications to foliage, for example. Such dermal applications could be considered “low volume” applications.

Low volume dermal applications (typically to foliage) using prior art spray equipment have been used for some time. With these applications, smaller amounts of a with more concentrated herbicide are applied to foliage, green stems, and other parts of the plants that can absorb water-based herbicides. They can be advantageous for several reasons. First, low volume applications allow better targeting of species to ensure that non-target species are avoided. Second, because of this targeting, less herbicide can be used. See, e.g., Roehl J, Right of Way Management: High Quality Results from Low-Volume Herbicide. http://www.elp.com/index/display/article-display/256794/articles/utility-automation-engineering-td/volume-11/issue-5/features/row-management-high-quality-results-from-low-volume-herbicide.html. Third, low volume spraying allows an increase in droplet size. This can be helpful because larger droplets may result in greater absorption and translocation of active ingredient. Feng P C C, Chiu T, R D Sammons, Ryerse J S, Droplet Size Affects Glyphosate Retention, Absorption, and Translocation in Corn, Weed Science, 2004; 51:443-448. Fourth, the increased droplet size generally means less drift than with smaller droplets. Smaller droplets are more prone to drift because they volatilize more easily and are lighter.

Low volume applications when made to foliage use a formulation that is “usually in the range of five to ten times more concentrated.” Grover A, Factsheet: Tips for Managing Problem Weeds in Forest and Wildland Settings, Penn State Roadside Research Project, 2004. For such low volume applications, the Nufarm Credit label recommends a “5 percent solution for annual and perennial weeds and a 5 to 10 percent solution for woody brush and trees.”

There are however, disadvantages to low volume spraying of foliage using prior art sprayers. One disadvantage is that larger droplets tend to roll off leaves more readily and therefore are not retained by the leaves as well. Feng et al. 2004. This can result in environment harm and herbicide waste.

Retention on surfaces is one reason that a concentrated herbicide foam 412 can be beneficial. Unlike large droplets that can easily roll off leaves, an herbicide foam 412 can stick quite well even to waxy leaves. In fact, a high quality foam can even stick well to vertical glass surfaces that liquids will quickly run down. Another advantage is that foams can decrease evaporation time. Evaporation can reduce the effectiveness of an herbicide such as glyphosate. Leaper C, Holloway P J, Adjuvants and Glyphosate Activity, Pest Manag Sci 56:313-319 (2000).

For low volume applications of concentrated herbicide foam 412 to foliage in which the solution has a 5% to 10% herbicide solution, off-the-shelf herbicides may not be preferable. For example, as discussed above, Nufarm Credit, an off-the-shelf herbicide can produce acceptable foam when used at or near full strength in a foam dispenser. However, when diluted to a 5% or 10% herbicide solution in a solution, the foam 412 dispensed from a dispenser 400 becomes much more watery. It does not, for example, meet the criteria of the foam stacking test where a stack of foam is at least 0.5 in. tall for 15 seconds.

To produce high quality foam using dispenser 400 or other foaming devices, it can be preferable to add a foaming agent to a solution. Aquamaster™, EPA Reg. No. 524-343, is a glyphosate-based herbicide with approximately 54% active ingredient produced by Monsanto Company, 800 North Lindbergh Blvd, St. Louis, Mo. 63167. Foams are difficult to generate using Aquamaster by itself at any dilution level in a herbicide solution. Presumably that is because Aquamaster does not contain adjuvants such as surfactants that aid in foam generation. If a solution with a 5% or 10% herbicide solution is desired, a foaming agent can be added such as a surfactant containing an alkyl polyglycoside. One such surfactant is Jarfactant 425N from Jarchem Industries, 414 Wilson Avenue, Neward, N.J. 07105, CAS#110615-47-9, 68515-73-1. Jarfactant 425N can have 50.9% active ingredient. To create an herbicide solution having a 5% herbicide solution using Aquamaster (i.e., 5% active herbicide ingredient), sufficient quantity of Jarfactant 425N must be added to make the solution foam. Experimentation shows that solutions with 5% to 10% glyphosate active herbicide ingredient and approximately 1.0% to 10.0% alkyl polyglycoside (or approximately 2.0% to 20.0% Jarfactant 425N) produce high quality foam using dispensers 100, 200, 300 discussed in the previous embodiments. The level of surfactant can be varied depending on the type of foam sought. Usually, higher levels of the surfactant result in drier foams. Other surfactants could also be used. For example, Jarfactant 225 DK, CAS#68515-73-1 from Jarchem Industries could also be used.

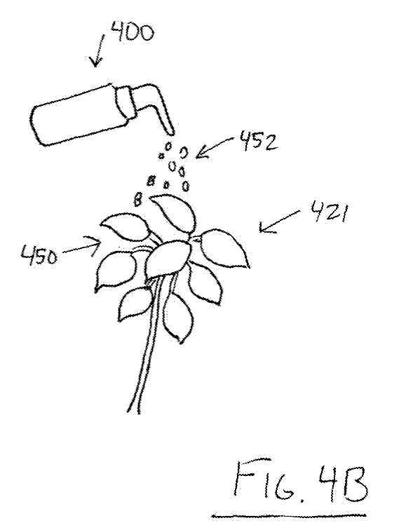

FIGS. 4A and 4B show examples of a low-volume application to foliage of weed plants 421 according to certain embodiments of the invention. In FIG. 4A, an application is being done with the nozzle in close proximity (perhaps a few inches) to a target leaf and stem 450. Since the target leaf and stem 450 are green, they should absorb herbicide. Such an application can be done once or repeated several times on the same weed. The solution for such an application might have a 5% or 10% glyphosate solution. It can have 1.0% to 10.0% APG (or another foaming surfactant) which is about 2.0% to 20.0% of a surfactant such as Jarfactant 425N.

FIG. 4B shows an application to the leaves 451 of a weed. In this example, foam clusters 452—approximately 0.10 in to 1.0 in. in size—are being drizzled onto the leaves 451 from a short distance—perhaps six inches to a few feet. In addition, a low-pressure dispenser 400 can also project clusters horizontally some distance. In experiments, the foam clusters 452 could be projected a distance of approximately seven feet. Such a technique (not shown) could also be used for low volume applications to foliage.

Similarly, to create solutions with higher concentrations of active herbicide ingredient—from 10% to 40%, AquaMaster and Jarfactant 425N can be used. Higher herbicide concentrations could be useful for sub-dermal applications such as cut-stump, frill, and injection techniques as discussed in relation to FIGS. 2A to 2H. For example, an herbicide solutions containing 27% glyphosate and 2% to 12% APG produce high quality foam when used in dispenser 100. At higher concentrations of APG, above approximately 10%, the foam may become dryer. Foams that are too dry may be less preferable for some herbicide applications. They may contain less active herbicide ingredient; it may not absorb as well into plant tissue; and it may be more prone to drift.

There are other advantages to using herbicides such as AquaMaster which are sold without foaming agents or other surfactants. First, AquaMaster and other selected herbicides are labeled for use at aquatic sites. Aquatic sites are often highly valued for their flora and fauna and therefore it is particularly desirable at such sites to use highly targeted application methods such as those possible with the invention. However, most surfactants in off-the-shelf herbicides are not appropriate for aquatic sites such as wetlands. For example, Nufarm Credit™ and Roundup™ have “inert ingredients” which make them inappropriate for aquatic sites.

By adding to AquaMaster (or similar herbicide labeled for aquatic sites) a suitable foaming agent having low human and aquatic toxicity, the herbicide solution can be used at aquatic sites. A foaming agent such as APG has low human and aquatic toxicity. Ruiz C C, Sugar=Based Surfactants: Fundamentals and Applications, CRC Press, 2008. Therefore, an herbicide solution containing an herbicide such as AquaMaster and an adjuvant such as APG should be permissible for use at aquatic sites.

Second, if a foaming agent is added as an adjuvant by the user, the user can customize the herbicide solution to make sure the quality of the foam suits the intended use. This allows the user to mix herbicide solutions suitable for foliar or for sub-dermal applications.

In various embodiments of the invention, different concentrated herbicide besides glyphosate and other dispensers could be used. Non-limiting examples other herbicides include 2,4-D, 2,4-MCPA, ametryn, aminopyralid, asulam, atrazine, butafenacil, carfentrazone-ethyl, chlorflurenol, chlormequat, chlorpropham, chlorsulfuron, chlortoluron, cinosulfuron, clethodim, clopyralid, cyclosulfamuron, pyroxsulam, dicamba, dichlobenil, dichlorprop-P, diclosulam, diflufenican, diflufenzopyr, diuron, fluoroxypyr, hexazinone, imazamox, imazapic, imazapyr, imazaquin, imazethapyr, imazosulfuron, MCPA, metsulfuron-methyl, picloram, pyrithiobac-sodium, sethoxydim, sulfometuron, sulfosate, sulfosulfuron, tebuthiuron, terbacil, thiazopyr, thifensulfuron, triasulfuron, tribenuron, and triclopyr.

### Example 3

This example can relate to the foam dispenser described in the first set of embodiments in relation to FIG. 1A; in the second set of embodiments in relation to FIGS. 2A to 2H; and in the fourth set of embodiments in relation to FIGS. 4A to 4B. As noted above, Rexam Airspray manufactures several foam dispensers that can be used.

Applicant had application testing done using a Rexam Airspray F2-L11 Finger Pump Foamer. This test estimated that pressure during what can be considered a typical use. For an herbicide, an off-the-shelf product was used: Hi-Yield, Super Concentrate Killzall™ Weed and Grass Killer with glyphosate (N-(phosphonomethyl glycine) in the form of its isopropylamine salt 41% (Acid equivalent of glyphosate content=30.34%), EPA Reg. No. 7401-451 and produced for Voluntary Purchasing Groups, Inc., 230 FM 87, Bonham, Tex. 75418. The mix tested contained 120 ml Hi-Yield Killzall and 20 ml water.

Pressures within the air chamber 160 and liquid chamber 161 contained in the mixing chamber 111 were estimated based on measurements of volume and trigger 106 press forces and calculations. Press forces on the trigger 106 between approximately 5 and 10 pounds were estimated to result in the creation of 1 to 5 psi (gauge) for the air in the air chamber 160. When these pressures are used, a frothy stable foam was created using the F2-L11 dispenser. The foam met the 15 second stacking test by creating a foam pile at least 0.5 in. to 2.5 in. high within a 1.5 in. circle for at least 15 seconds as described in relation to FIGS. 4A and 4B. Moreover, the foam can generally persist beyond 3 minutes and often for several hours though typically not for more than three or four hours. (This depends in part on the kind of target surface and its configuration. For example, foams applied in cavities can generally persist for longer times.)

It is unknown what surfactants are contained in the Hi-Yield Killzall formulation as tested. However, it is presumed that a foaming surfactant is included. However, for most spray apparatus of the kind included on the label for Hi-Yield Killzall, foaming is undesirable. Therefore, it is surprising that the Hi-Yield Killzall formulation foams as well as it does.

### Example 4

As mentioned above, other herbicide solutions can be used. An alkyl polyglycoside (APG) such as Jarfactant 425N or 225DK can be used as a surfactant with an herbicide containing glyphosate such as AquaMaster™.

APG is considered a nonionic surfactant. There are many nonionic surfactants. However, not all nonionic surfactants help produce foam, i.e., are foaming agents. In fact, some nonionic surfactants are used as defoamers or antifoamers. Either the Jarfactant 425N or the 225DK produce high quality foam when used with the Rexam Airspray F2-L11 foamer.

The advantage of APG is that it has low aquatic toxicity. APG is also biodegradable in both aerobic and anaerobic (or nonaerobic) conditions. It is considered “readily biodegradable” in aerobic conditions. See Madsen T, Burhardt Boyd H, Nylen D, Rathmann Pedersen A, Petersen G I, Simonson F, Environmental and Health Assessment of Substances in Household Detergents and Cosmetic Detergent Products, Environmental Project, No. 615 2001 (incorporated by reference.)

Applicant conducted foam stacking tests using the off-the-shelf AquaMaster diluted 50% with distilled water and different amounts of APG ranging from 1.0% to 10.0% alkyl polyglycoside by weight (or approximately 2.0% to 20.0% Jarfactant 425N by weight). The foam can meet the foam stacking test by creating a foam pile at least 0.5 in. to 2.5 in. high within a 1.5 in. circle 319 for at least 15 seconds as described in relation to FIGS. 4A and 4B.

### Other Embodiments

It should be noted that other embodiments (not shown) could be configured differently than as described above.

While the above-discussed embodiments of the present invention generally related to foam herbicide, a foamable pesticide dispenser and associated methods of using a dispenser to apply foamed solutions such as pesticide formulations to plants, the invention is not so limited. The dispenser, for example, may be useful for other purposes, such as the application of foamable growth stimulants, nutrients or other chemicals. The invention should be understood to encompass these other uses although such other uses may not be discussed below.

The invention herein above has been described with reference to various and specific non-limiting embodiments, examples and techniques. It will be understood by one of ordinary skill in the art, however, that reasonable variations and modifications may be made with respect to such embodiments and techniques without substantial departure from either the spirit or scope of the invention defined by the following claims. For example, while suitable sizes and parameters, materials, packaging and the like have been disclosed in the above discussion, it should be appreciated that these are provided by way of example and not of limitation as a number of other sizes and parameters, materials, fasteners, and so forth may be used without departing from the spirit of the invention.

What is claimed:

1. A foamable solution dispenser, comprising:
a foamable solution container and a mechanical foaming head, the foaming head comprising a mixing chamber configured with an air chamber, a liquid chamber and a manifold for receiving and mixing air and the foamable solution into a foam,
wherein the foamable solution is disposed in the container and wherein the foamable solution comprises an active ingredient, water and a foaming agent.

2. The dispenser of claim 1, wherein the active ingredient is an active ingredient for application to plants.

3. The dispenser of claim 2, wherein the active ingredient is an herbicide.

4. The dispenser of claim 3, wherein the active ingredient is a glyphosate herbicide.

5. The dispenser of claim 2, wherein the foaming agent is an alkyl glycoside or an alkyl polyglycoside.

6. The dispenser of claim 3, wherein the active ingredient is a glyphosate herbicide and the foaming agent is an alkyl glycoside or an alkyl polyglycoside.

7. The dispenser of claim 2, wherein the dispenser is configured to deliver foam under low pressure.

8. The dispenser of claim 2, wherein the foaming head has a trigger, an elongated nozzle tip, and an orifice for delivery of foam.

9. The dispenser of claim 8, wherein the nozzle tip is removably attached to the trigger.

10. The dispenser of claim 8, wherein the nozzle tip is permanently affixed to the trigger.

11. The dispenser of claim 2, wherein the dispenser is configured to deliver foam under pressures of less than 20 psi, or of between less than 20 psi to about 0.5 psi, or from about 15 psi to about 0.5 psi, or from about 15 psi to about 10 psi, or from about 10 psi to about 0.5 psi, or from about 10 psi to 5 psi, or from about 5 psi to about 0.5 psi, or from about 5 psi to about 3 psi, or from about 3 psi to about 0.5 psi.

12. The dispenser of claim 2, wherein the dispenser is configured to deliver foam under a pressure ranging from about 5 psi to about 0.5 psi.

13. A foamable solution, comprising an active ingredient for application to plants, water and a foaming agent.

14. The solution of claim 13, wherein the active ingredient is an herbicide.

15. The solution of claim 13, wherein the foaming agent is an alkyl glycoside or an alkyl polyglycoside.

16. The solution of claim 14, wherein the herbicide is a glyphosate herbicide.

17. The solution of claim 13, wherein the foaming agent is present in an amount ranging from about 9.9 wt % to about 0.15 wt %.

18. The solution of claim 13, wherein the foaming agent is present in an amount ranging from about 6.0 wt % to about 1.0 wt %.

19. The solution of claim 13, wherein the foaming agent is aerobically readily biodegradable.

20. A foamable solution, comprising an active ingredient for application to plants, water and a foaming agent, wherein the foaming agent is aerobically readily biodegradable.
